(19) United States
(12) Patent Application Publication
(10) Pub. No.: US 2003/0042662 A1
(43) Pub. Date: Mar. 6, 2003

(54) Clamp assembly for servicing electronic circuits

(76) Inventor: Christian Louis Ternel, Hammondville (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/944,950

(22) Filed: Aug. 31, 2001

(51) Int. Cl. B25B 1/20

(52) U.S. Cl. 269/43

(57) ABSTRACT

A clamp assembly for servicing electronic circuits is disclosed. The clamp assembly has two or more clamps (1, 2). The clamps are mounted on a rod (3) extending through each clamp. The space between the clamps may be stably increased or reduced by simply sliding one or both of the clamps along the rod to engage the ball bearing in each clamp on a dimple in the rod. A bushing is used as a pivot for each clamp. The rod passes through the bushing and the bushing holds the flanges of the clamp together on the rod. A spring (6) is fitted to the clamp arms (5A) by a locating dowel on each arm of the clamp. Squeezing the ends (5A) of the lever arms together allows the clamp to open. Each of the clamps is preferably lined with an insulating and heat resistant ceramic or plastic pad. These pads have V-shaped grooves formed in them to assist in the holding of small electrical components or electrical leads. This allows wiring etc. to be clamped in position in the jaws to facilitate soldering without having to hold the components while soldering.

### BACKGROUND OF THE INVENTION

This invention relates to an aid for servicing electronic circuits. More particularly, although not exclusively, it discloses a clamp assembly for assisting the connection of electrical components and wiring.

The servicing of circuits such as, for example, those installed in contemporary pinball machines or the like, typically require working with a myriad of miniature electronic components and wiring. Those components being serviced have to be held in precise stable alignment with the circuit board or other device during the soldering process. Any movement during soldering weakens the joint and can lead to subsequent failure of the connection. Moreover as the circuitry is often located in confined spaces, service operations using currently available equipment are time consuming and difficult.

### BRIEF SUMMARY OF THE INVENTION

It is therefore an object of this invention to ameliorate the aforementioned disadvantages and accordingly a clamp assembly for assisting the assembly or repair of electronic circuits is disclosed. This clamp assembly includes a pair of spring loaded clamps adapted for releasably holding electronic components, wire leads or the like in alignment prior to connection, said pair of clamps being mounted in a spaced apart configuration by a rod extending there between and said pair of clamps being moveable along said rod to adjust the spacing there between.

Preferably said rod has a square shaft with dimples at regular intervals on each side of the four faces. Each of the spring loaded clamps are aligned with a dimple on the rod by a spring loaded ball bearing that allows movement along the rod towards or away from each other. One clamp preferably does not rotate, but the other may do so in increments of 90° because the end of the shaft is rounded.

### BRIEF DESCRIPTION OF THE DRAWINGS Preferred embodiments of the invention will now be described with reference to the attached drawings in which:

FIG. 1 shows a perspective view of a clamp assembly according to this invention with the clamps in the closed position.

FIG. 2A shows a side view of the components of one of the clamps of FIG. 1,

FIG. 2B shows an end view of a first arm of the clamp of FIG. 3A,

FIG. 2C shows an end view of a second arm of the clamp of FIG. 3A,

FIG. 3 shows a detailed view of one of the clamp in the open position,

FIG. 4 shows a perspective view of a second example of a clamp assembly according to this invention with the clamps in the closed position, and,

FIG. 5 shows a detailed view of one of the clamp of FIG. 4 in the closed position,

FIG. 6A shows a side view of a first arm of the clamp of FIG. 4,

FIG. 6B shows a plan view of a first arm of the clamp of FIG. 4,

FIG. 6C shows a side view of a second arm of the clamp of FIG. 4,

FIG. 6D shows a plan view of a second arm of the clamp of FIG. 4,

### DETAILED DESCRIPTION OF THE INVENTION

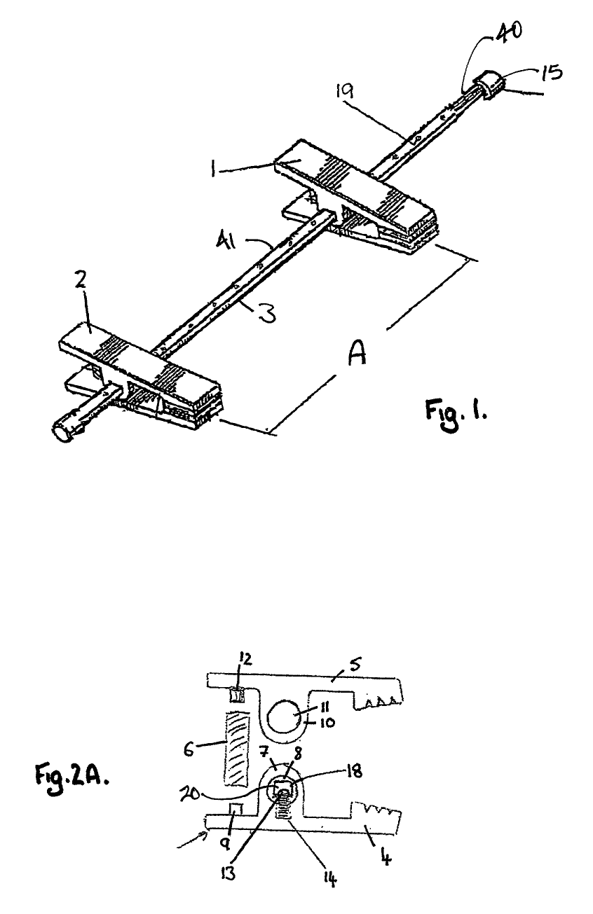

Referring first to FIG. 1, there are shown two clamps, 1, 2 which are adapted for releasably holding small electronic components, electrical leads or the like. The clamps are mounted in a spaced apart, parallel arrangement by means of a rod, 3 extending through each clamp.

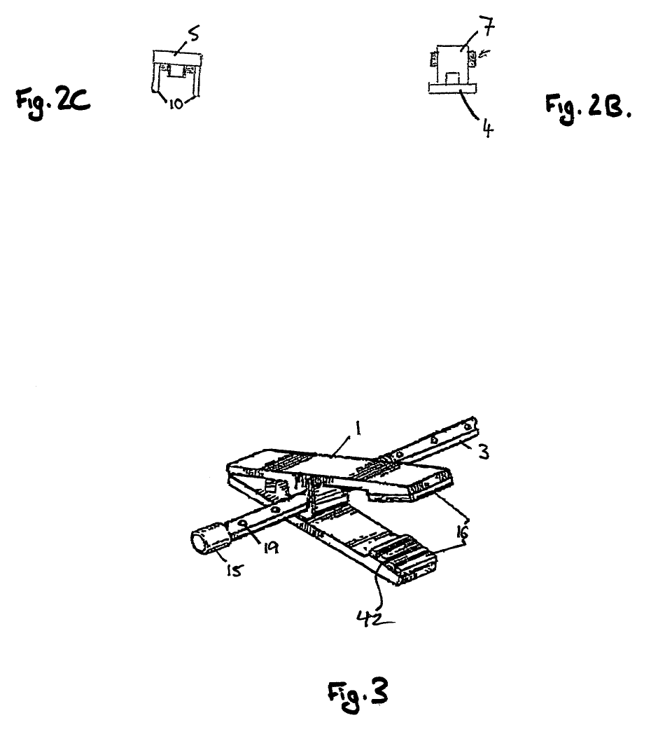

The construction of each clamp is shown in more detail in FIGS. 2A, 2B and 2C. As shown, the clamp 1 is formed from two arms 4,5 coupled together via a spring 6. The arm 4 includes two flanges 7 that each have an aperture 8, and a locating dowel 9, which is used for locating the spring 6 in use. Similarly, the other arm 5 includes two flanges 10, each of which has an aperture 11, together with a locating dowel 12.

When the arms 4,5, are brought into alignment, the flanges 7,10 cooperate so that the apertures 8,11 are aligned. A bushing 18 is inserted in the formed aperture so as to allow the clamp to be mounted on the rod 3, as shown in FIG. 1.

The bushing 18 includes a ball bearing 13 that is mounted in the bushing 18 using a spring 14. The spring 14 allows the ball bearing 13 to retract inside the bushing, thereby allowing the rod to be inserted through the bushing 18. Accordingly, the clamps can be moved along the rod, allowing a space “A” between them. This space “A” may be increased or reduced by simply sliding one or both of the clamps 1,2 along the rod. As the clamps move along the rod, the ball bearing engages in one of the dimples 19 along the rod to hold the clamp in place.

Accordingly, by virtue of a spring loaded bearing in each clamp, the space “A” between them may be increased or reduced by simply sliding one or both of the clamps along the rod to engage the ball bearing 13 in one of the dimples 19 along the rod.

As shown in FIG. 2A, the bushing 18 has a square aperture 20 to receive the rod 3. It will be appreciated from this that the clamps, while being able to move between the closed positions shown in FIG. 1 and the open position shown in FIG. 3, are unable to rotate along the square portion of the rod 3. However, the relative orientation of the clamps can be adjusted by moving one of the clamps 1,2 to the end of the rod 40 (FIG. 1). At this point, the end of the rod 40 is tapered and rounded to allow rotation of the clamps. The clamp can be moved onto the end 40, allowing the clamp to be rotated by 90° are then replaced on the square portion of the rod. Accordingly, the clamp can be rotated in 90° increments. End pieces 15 can be made larger than the bushings to prevent the clamps from falling off the end of the rod 3. Rather than tapering and rounding the end of the rod 40, end pieces 15 can be removable to allow the relative angular orientation of the clamps 1,2 to be adjusted.

Finally, the spring 6 is fitted to the arms 4,5 by the locating dowels 9, 12. By virtue of the aforementioned arrangement each clamp 1,2 is biased by its respective spring 6 into the closed position of FIG. 1. Squeezing the ends 5A of the lever arms together however opens the jaws to the position of FIG. 3.

Each of the clamps is preferably lined with an insulating and heat resistant ceramic or plastic pad 16. These pads 16 have V-shaped grooves 42 formed in them to assist in the holding of small electrical components or electrical leads.

Accordingly, in use of the clamp assembly, small electrical components or electrical leads which require joining are clamped by the respective clamps. Sliding of the clamps along the rod allows the components to be moved into place and held at the precise positions required for connection. Once so placed, both of the technician's hands are then free to attend to the soldering operation without risk of the components moving or becoming misaligned before the solder hardens.

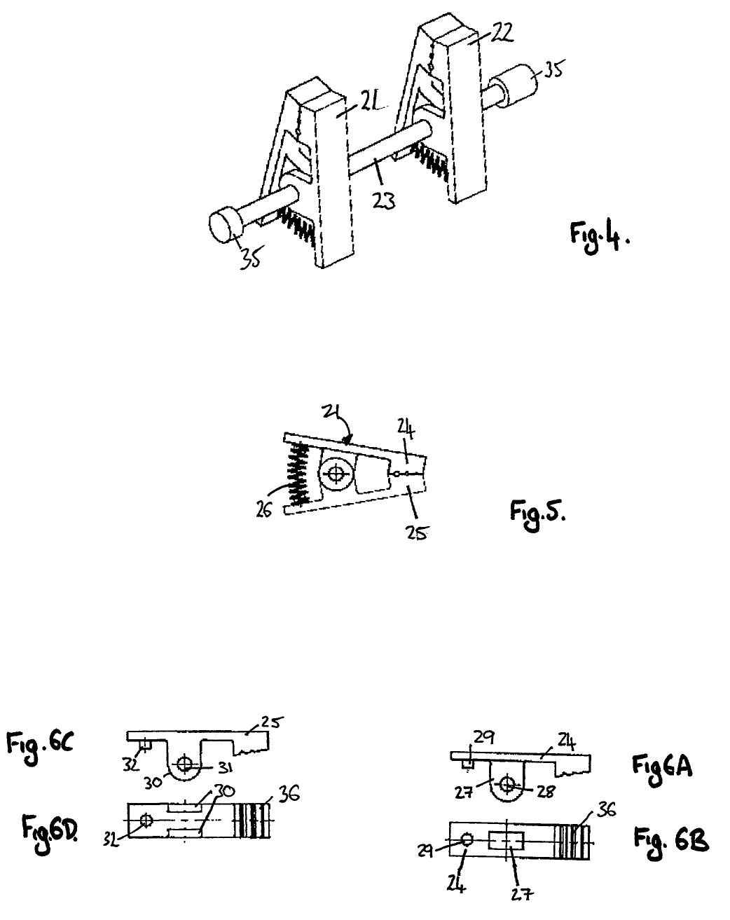

A second example of the present invention, which is shown in FIG. 4, includes two clamps 21, 22 mounted in a spaced apart, parallel arrangement on a rod 23. The construction of one of the clamps is shown in more detail in FIGS. 5 and 6A to 6D.

As shown, the clamp 21 is formed from two arms 24, 25, coupled together via a spring 26. The upper arm 24 includes a flange 27 that has an aperture 28, and a locating dowel 29, which is used for locating the spring 26 in use. Similarly the arm 25 includes two flanges 30, each of which has an aperture 31, together with a locating dowel 32. Each arm 24, 25 also includes a pad 36, similar to the pads 16 of the first example, to assist in the holding of small electrical components or electrical leads.

When the arms 24, 25, are brought into alignment, as shown in FIG. 5, the flanges 27, 30 cooperate so that the apertures 28, 31 are aligned to form an aligned aperture, through which the rod 23 extends in use. With the rod 23 is in position, the clamps are able to open and close.

In use, the spring 26 is coupled to the arms 24, 25 using the locating dowels 29, 32. In this arrangement, the spring 26 operates to urge the pair of jaws 21 into the closed position shown in FIG. 5. By suitable selection of the spring 26, the spring 26 will still apply a force when the clamps are in the closed position to try and urge the arms 24, 25 further apart. In this case, further motion of the arms is restricted by the presence of the rod in the apertures 28, 31. Accordingly, the flanges 27, 30 are urged against the rod 23. This action generates a friction between the rod 23 and the flanges 27, 30, thereby restricting movement of the rod 23 through the apertures 28, 31. This in turn acts to hold the clamps 21, 22 in position for use.

If repositioning of the clamps is required, this can be achieved by pushing the arms together to compress the spring 26. With the spring 26 compressed due to the external force, the arms 24, 25 are no longer urged apart so the flanges 27, 30 are no longer urged against the rod 23. As a result, the clamps can be slid along the rod 23, allowing the position of the clamps to be adjusted. Furthermore, in this example, the rod has a circular cross section, allowing the clamps to be freely rotated relative to each other.

Finally, as shown in FIG. 4, the rod 23 includes end pieces 35 that have a larger diameter than the apertures 28, 31, to thereby prevent the clamps 21, 22 being removed off the rod 23.

It will thus be appreciated that this invention, at least in the form of the embodiments disclosed, provides a novel and useful aid for the servicing electronic circuits. Clearly however, the examples described are only the currently preferred forms of this invention and a wide variety of modifications may be made which would be apparent to a person skilled in the art. For example the shape and size of the clamps and rod may be changed to suit other applications, such as to hold two pieces of pipe together to allow soldering of a joint. For these reasons, the scope of the invention is limited only by the appended claims.

What is claimed is:

1. A clamp assembly for servicing electronic circuits comprising a rod on which a plurality of clamps are movably mounted.

2. The clamp assembly for servicing electronic circuits in claim 1, further comprising spring loaded ball bearings on the clamps to allow the clamps to be stably moved closer or further apart along the rod by being received into dimples formed along the rod.

3. The clamp assembly for servicing electronic circuits in claim 1, the rod having one or more rounded portions to allow a clamp to be rotated in increments of 90°.

4. The clamp assembly of claim 1, wherein each clamp comprises first and second arms, each arm having an aperture for receiving the rod to thereby allow movement of the clamps along the rod.

5. The clamp assembly of claim 4, each clamp includes a spring coupled to the arms to urge the arms into a closed position.

6. The clamp assembly of claim 5, wherein when the clamp is in the closed position, the spring further operates to urge the apertures against the rod, thereby restricting movement of the clamp.

7. The clamp assembly of claim 1, wherein each clamp further includes heat resistant pads for gripping the electronic components to be serviced.
